(19) United States
(12) Patent Application Publication
(10) Pub. No.: US 2018/0024738 A1
(43) Pub. Date: Jan. 25, 2018

(54) DATA READING METHOD, DATA WRITING METHOD AND STORAGE CONTROLLER USING THE SAME

(71) Applicant: EpoStar Electronics Corp., Hsinchu City (TW)

(72) Inventor: Di-Hsien Ngu, Hsinchu County (TW)

(73) Assignee: EpoStar Electronics Corp., Hsinchu City (TW)

(21) Appl. No.: 15/264,603

(22) Filed: Sep. 14, 2016

(30) Foreign Application Priority Data
Jul. 22, 2016 (TW) 105123217

(51) Int. Cl. G06F 3/06; G06F 12/02

(52) U.S. Cl. CPC G06F 3/061; G06F 3/064; G06F 3/0659; G06F 3/0665; G06F 3/0679; G06F 12/0246; G06F 2212/1016; G06F 2212/152; G06F 2212/214

(57) ABSTRACT

A data reading method is provided. The method includes receiving a read command from a host system, wherein the read command includes a starting logical block address, a number of logical blocks, a first physical region page pointer, and a second physical region page pointer, and the read command is configured to read target data from at least one target logical block of a rewritable non-volatile memory module and write the read target data into at least one target memory page of a host memory; obtaining an address of each of the target memory pages respectively corresponding to the at least one target logical block according to the read command; and selecting a first target logical block from the at least one target logical block, and writing the read first target data into a first target memory page according to the obtained address of the first target memory page.

### CROSS-REFERENCE TO RELATED APPLICATION

This application claims the priority benefit of Taiwan application serial no. 105123217, filed on Jul. 22, 2016. The entirety of the above-mentioned patent application is hereby incorporated by reference herein and made a part of this specification.

### BACKGROUND

### Technical Field

The invention relates to a data transfer method, and more particularly, to a data reading method, a data writing method and storage controllers using the methods.

### Description of Related Art

The growth of digital cameras, mobile phones, and MP3 players has been rapid in recent years. Consequently, the consumers' demand for storage media has increased tremendously. A rewritable non-volatile memory is one of the most adaptable memories for said electronic products due to its data non-volatility, low power consumption, small volume, non-mechanical structure and high read/write speed. For these reasons, the flash memory has become an import part of the electronic industries. For example, an eMMC (embedded Multi Media Card) widely adopted in mobile electronic device is one storage device that uses the flash memory as a storage medium.

To cooperate with higher write/read speed of a rewritable non-volatile memory storage device (e.g., a solid state drive), many data transfer interfaces (e.g., Peripheral Component Interconnect Express; PCIe interface) have started to support data transfer protocol of higher level, such as a Non-Volatile Memory express (NVMe) interface standard, so as to provide a working efficiency of the rewritable non-volatile memory storage device in high speed.

The NVMe interface standard defines a plurality of access commands for user data transfer. The access commands have various command parameters. In general, a storage controller of the existing rewritable non-volatile memory storage device can sequentially access data according to said command parameters of the received access commands.

Storage units corresponding to the data in the rewritable non-volatile memory storage device are not always ready for access. Therefore, in order to sequentially access the data corresponding to the access commands according to the access commands, the storage controller spends time waiting until all the storage units corresponding to the data are ready before sequentially performing data access operations according to instruction from the access commands. As such, the store controller may waste time on the process of waiting. On the other hand, in order to accelerate a processing speed, it is also possible that the storage controller needs to temporarily store data accessed in advance corresponding to the storage units which are ready. Accordingly, resources may be wasted for temporarily storing data to cause a higher cost.

Therefore, it is one of the major subjects in the industry as how to properly use the command parameters included by the access commands in the NVMe interface standard to reduce the process of waiting for the storage controller and reduce the requirement on resources for temporarily storing data to be accessed, so as to improve efficiency on data access while reducing waste on the resources.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The invention is directed to a data reading method, a data writing method, and storage controllers using the methods, which are capable of reducing the process of waiting for the storage controllers while reducing requirements for temporarily storing data to be read/written.

An embodiment of the invention provides a data reading method, which is suitable for reading data from a rewritable non-volatile memory module into a host memory of a host system. The rewritable non-volatile memory module is assigned with a plurality of logical blocks, and the host memory has a plurality of memory pages. The method includes: receiving a read command from a host system. The read command includes a starting logical block address, a number of logical blocks, a first physical region page pointer, and a second physical region page pointer. The read command is configured to read target data from at least one target logical block of the rewritable non-volatile memory module and write the read target data into at least one target memory page of the host memory. The target data is stored starting from a starting logical block in the at least one target logical block. The starting logical block address is configured to indicate an address of the starting logical block. The number of logical blocks is configured to indicate a number of the logical blocks storing the target data in the at least one target logical block. The first physical region page pointer is configured to indicate a first memory page address of the host memory, and the second physical region page pointer is configured to indicate a second memory page address of the host memory. An address of each of the target memory pages respectively corresponding to the at least one target logical block is obtained according to the starting logical block address, the number of logical blocks, the first physical region page pointer, and the second physical region page pointer. A first target logical block is selected from the at least one target logical block. First target data stored by the first target logical block is read. The read first target data is written into a first target memory page according to the obtained address of the first target memory page corresponding to the first target logical block.

Another embodiment of the invention includes data writing method, which is suitable for writing data from a host memory of a host system into a rewritable non-volatile memory module. The rewritable non-volatile memory module is assigned with a plurality of logical blocks, and the host memory has a plurality of memory pages. The method includes: receiving a write command from a host system. The write command includes a starting logical block address, a number of logical blocks, a first physical region page pointer, and a second physical region page pointer. The write command is configured to write target data into at least one target logical block of the rewritable non-volatile memory module. A foremost logical block sorted in the at least one target logical block is a starting logical block. The starting logical block address is configured to indicate an address of the starting logical block. The number of logical blocks is configured to indicate a number of the logical blocks storing the target data in the at least one target logical block. The first physical region page pointer is configured to indicate a first memory page address of the host memory, and the second physical region page pointer is configured to indicate a second memory page address of the host memory. The target data corresponding to the write command is stored in at least one target memory page among the memory pages of the host memory. An address of each of the target memory pages respectively corresponding to the at least one target logical block is obtained according to the starting logical block address, the number of logical blocks, the first physical region page pointer, and the second physical region page pointer. Each of the target memory pages respectively corresponding to the target logical blocks is one of the at least one target memory page. A first target logical block is selected from the at least one target logical block. First target data is read according to the obtained address of a first target memory page corresponding to the first target logical block. The read first target data is written into the first target logical block.

An embodiment of the invention provides a storage controller, which is configured to control a storage device having a rewritable non-volatile memory module. The storage controller includes a connection interface circuit, a memory interface control circuit, a processor and a data transfer management circuit. The connection interface circuit is configured to couple to a host system. The host system has a host memory. The host memory has a plurality of memory pages. The memory interface control circuit is configured to couple to the rewritable non-volatile memory module. The rewritable non-volatile memory module is assigned with a plurality of logical blocks. The processor is coupled to the connection interface circuit and the memory interface control circuit. The data transfer management circuit is coupled to the processor, the connection interface circuit and the memory interface control circuit. The processor is configured to receive a read command from the host system. The read command includes a starting logical block address, a number of logical blocks, a first physical region page pointer, and a second physical region page pointer. The read command is configured to read target data from at least one target logical block of the rewritable non-volatile memory module and write the read target data into at least one target memory page of the host memory. The target data is stored starting from a starting logical block in the at least one target logical block. The starting logical block address is configured to indicate an address of the starting logical block. The number of logical blocks is configured to indicate a number of the logical blocks storing the target data in the at least one target logical block. The first physical region page pointer is configured to indicate a first memory page address of the host memory, and the second physical region page pointer is configured to indicate a second memory page address of the host memory. The processor is configured to instruct the data transfer management circuit to obtain an address of each of the target memory pages respectively corresponding to the at least one target logical block according to the starting logical block address, the number of logical blocks, the first physical region page pointer, and the second physical region page pointer. The memory interface control circuit is configured to select a first target logical block from the at least one target logical block, and read first target data stored by the first target logical block. The data transfer management circuit is configured to write the read first target data into a first target memory page according to the obtained address of the first target memory page corresponding to the first target logical block.

An embodiment of the invention provides a storage controller, which is configured to control a storage device having a rewritable non-volatile memory module. The storage controller includes a connection interface circuit, a memory interface control circuit, a processor and a data transfer management circuit. The connection interface circuit is configured to couple to a host system. The host system has a host memory. The host memory has a plurality of memory pages. The memory interface control circuit is configured to couple to the rewritable non-volatile memory module. The rewritable non-volatile memory module is assigned with a plurality of logical blocks. The processor is coupled to the connection interface circuit and the memory interface control circuit. The data transfer management circuit is coupled to the processor, the connection interface circuit and the memory interface control circuit. The processor is configured to receive a write command from the host system. The write command includes a starting logical block address, a number of logical blocks, a first physical region page pointer, and a second physical region page pointer. The write command is configured to write target data into at least one target logical block of the rewritable non-volatile memory module. A foremost logical block sorted in the at least one target logical block is a starting logical block. The starting logical block address is configured to indicate an address of the starting logical block. The number of logical blocks is configured to indicate a number of the logical blocks storing the target data in the at least one target logical block. The first physical region page pointer is configured to indicate a first memory page address of the host memory, and the second physical region page pointer is configured to indicate a second memory page address of the host memory. The target data corresponding to the write command is stored in at least one target memory page among the memory pages of the host memory. The processor is configured to instruct the data transfer management circuit to obtain an address of each of the target memory pages respectively corresponding to the at least one target logical block according to the starting logical block address, the number of logical blocks, the first physical region page pointer, and the second physical region page pointer. Each of the target memory pages respectively corresponding to the target logical blocks is one of the at least one target memory page. The memory interface control circuit is configured to select a first target logical block from the at least one target logical block, The data transfer management circuit is configured to read first target data according to the obtained address of a first target memory page corresponding to the first target logical block, and the memory interface control circuit is further configured to write the read first target data into the first target logical block.

Based on the above, the data transfer (reading/writing) method provided in various embodiments of the invention allows the storage controller to non-sequentially and directly access the part of storage units ready for being accessed without spending time waiting for all of the storage units to become ready for being accessed. As such, the storage controller may be prevented from wasting too much time on the process of waiting while reducing the temporary storage area and resources spent for sequential access. Also, the address of the target memory page corresponding to the target logical block may be calculated rapidly through hardware to accelerate the speed of data transfer while reducing loadings on the processor of the storage controller, so as to improve the working efficiency for the storage device and its data transfer operation.

To make the above features and advantages of the invention more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a host system and a storage device according to an embodiment of the invention.

FIG. 2 is a flowchart illustrating a data reading method according to an embodiment of the invention.

FIG. 3 is a flowchart illustrating a data writing method according to an embodiment of the invention.

FIG. 4 is a schematic diagram illustrating a memory page according to the first embodiment of the invention.

FIG. 5 is a flowchart illustrating a data transfer according to the first and fourth embodiments of the invention.

FIG. 6 is a flowchart illustrating a data transfer according to the second and fifth embodiments of the invention.

FIG. 7 is a flowchart illustrating a data transfer according to the third and sixth embodiments of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally, a storage device includes a rewritable non-volatile memory module and a storage device controller (also known as a storage controller or a storage control circuit). The storage device is usually used together with a host system so the host system may write data into or read data from the storage device.

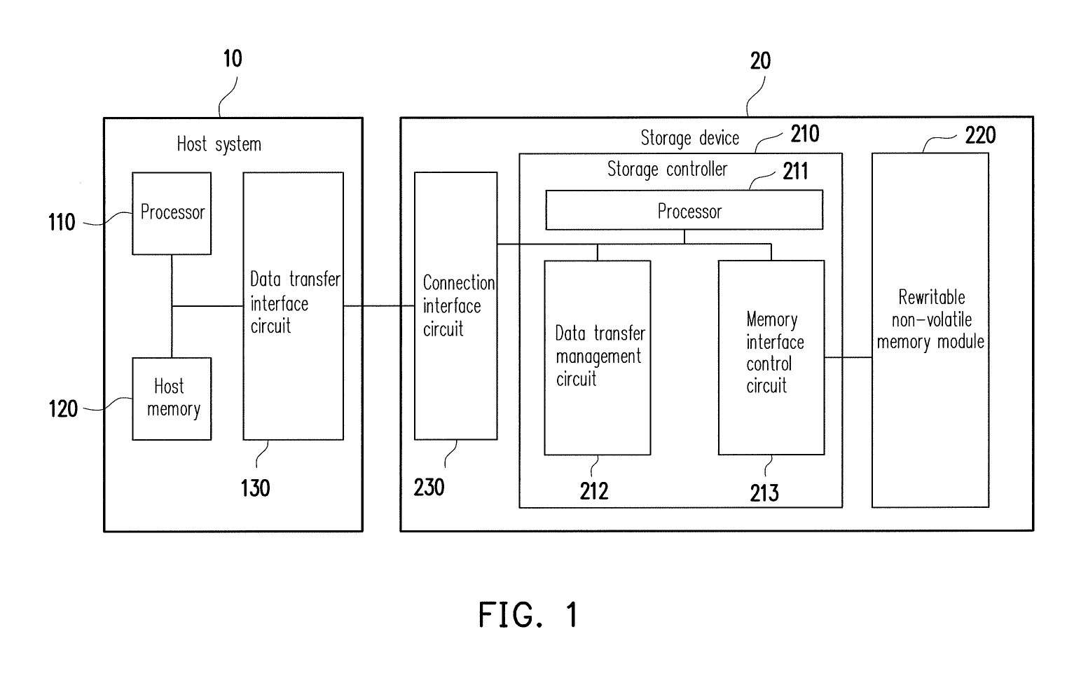

FIG. 1 is a block diagram illustrating a host system and a storage device according to an embodiment of the invention.

Referring to FIG. 1, a host system 10 includes a processor 110, a host memory 120 and a data transfer interface circuit 130. In the present embodiment, the data transfer interface circuit 130 is coupled to (or, electrically connected to) the processor 110 and the host memory 120. In another embodiment, the processor 110, the host memory 120 and the data transfer interface circuit 130 are coupled to one another by utilizing a system bus.

A storage device 20 includes a storage controller 210, a rewritable non-volatile memory module 220 and a connection interface circuit 230. Among them, the storage controller 210 includes a processor 211, a data transfer management circuit 212 and a memory interface control circuit 213.

In the present embodiment, the host system 10 is coupled to the storage device 20 through the data transfer interface circuit 130 and the connection interface circuit 230 of the storage device 20 to perform a data access operation. For example, the host system 10 can store data to the storage device 20 or read data from the storage device 20 through the data transfer interface circuit 130.

In the present embodiment, the processor 110, the host memory 120 and the data transfer interface circuit 130 may be disposed on a main board of the host system 10. The number of the data transfer interface circuit 130 may be one or more. Through the data transfer interface circuit 130, the main board may be coupled to the storage device 20 in a wired manner or a wireless manner. The storage device 20 may be, for example, a flash drive, a memory card, a solid state drive (SSD) or a wireless memory storage device. The wireless memory storage device may be, for example, a memory storage device based on various wireless communication technologies, such as a NFC (Near Field Communication) memory storage device, a WiFi (Wireless Fidelity) memory storage device, a Bluetooth memory storage device, a BLE (Bluetooth low energy) memory storage device (e.g., iBeacon). Further, the main board may also be coupled to various I/O devices including a GPS (Global Positioning System) module, a network interface card, a wireless transmission device, a keyboard, a monitor and a speaker through the system bus.

In the present embodiment, the data transfer interface circuit 130 and the connection interface circuit 230 are an interface circuit compatible with a Peripheral Component Interconnect Express (PCI Express) interface standard. Further, a data transfer is performed between the data transfer interface circuit 130 and the connection interface circuit 230 by using a communication protocol of a Non-Volatile Memory express (NVMe) interface standard.

Nevertheless, it should be understood that the invention is not limited thereto. The data transfer interface circuit 130 and the connection interface circuit 230 may also be compatible to a PATA (Parallel Advanced Technology Attachment) standard, an IEEE (Institute of Electrical and Electronic Engineers) 1394 standard, a USB (Universal Serial Bus) standard, a SD interface standard, a UHS-I (Ultra High Speed-I) interface standard, a UHS-II (Ultra High Speed-II) interface standard, a MS (Memory Stick) interface standard, a Multi-Chip Package interface standard, a MMC (Multi Media Card) interface standard, an eMMC interface standard, a UFS (Universal Flash Storage) interface standard, an eMCP interface standard, a CF interface standard, an IDE (Integrated Device Electronics) interface standard or other suitable standards. Further, in another embodiment, the connection interface circuit 230 and the storage controller 210 may be packaged into one chip, or the connection interface circuit 230 is distributed outside a chip containing the storage controller 210.

In the present embodiment, the host memory 120 is configured to temporarily store commands executed by the processor 110 or data. For instance, in the present exemplary embodiment, the host memory 120 may be a Dynamic Random Access Memory (DRAM), or a Static Random Access Memory (SRAM) and the like. Nevertheless, it should be understood that the invention is not limited thereto, and the host memory 120 may also be other appropriate memories. More specifically, in the present embodiment, the host memory 120 may be divided into a plurality of memory pages to be used in a storage management of the commands and the data. Each of the memory pages has a starting address (Starting Address of Memory Page; SAMP) and an ending address (Ending Address of Memory Page; EAMP). In the present embodiment, each of the memory pages is addressed by utilizing a 16-bit address. For example, the starting address (SAMP) of a foremost memory page being sorted may be set as “0000”, and the ending address (EAMP) thereof may set as “0FFF”. A size of each of the memory pages is 4096 bytes (i.e., 4 KB). A total space of the memory pages used for the data transfer by the host memory is 64 KB (i.e., 16 memory pages in total). However, the invention is not intended to limit an addressing scheme for the host memory. For example, in another embodiment, the host memory may include more or less space, and may correspondingly perform the addressing scheme with use of a proper addressing method.

The storage controller 210 is configured to execute a plurality of logic gates or control commands, which are implemented in a hardware form or in a firmware form, and to perform operations of writing, reading or erasing data in the rewritable non-volatile memory storage module 220 according to the commands of the host system 10.

More specifically, the processor 211 in the storage controller 210 is hardware with computing capabilities, which is configured to control overall operation of the storage controller 210. Specifically, the processor 211 has a plurality of control commands. These control commands are executed to perform various operations such as writing, reading and erasing data during operation of the storage device 20.

It is noted that, in the present embodiment, the processor 110 and the processor 211 are, for example, a central processing unit (CPU), a micro-processor, other programmable microprocessors, a digital signal processor (DSP), a programmable controller, an application specific integrated circuits (ASIC), a programmable logic device (PLD) or other similar circuit elements, which are not particularly limited by the invention.

In an embodiment, the storage controller 210 further includes a ROM (not illustrated) and a RAM (not illustrated). More particularly, the ROM has a boot code, which is executed by the processor 221 to load the control commands stored in the rewritable non-volatile memory module 220 into the RAM of the storage controller 210 when the storage controller 210 is enabled. Then, the control commands are executed by the processor 211 to perform operations, such as writing, reading or erasing data. In another embodiment, the control commands of the processor 211 may also be stored as program codes in a specific area (for example, physical storage units in the rewritable non-volatile memory module 220 dedicated for storing system data) of the rewritable non-volatile memory module 220.

In the present embodiment, as described above, the storage controller 210 further includes the data transfer management circuit 212 and the memory interface control circuit 213.

Among them, the data transfer management circuit 212 is coupled to the processor 211, the memory interface control circuit 213 and the connection interface circuit 230. The data transfer management circuit 212 is configured to receive instruction of the processor 211 to perform the data transfer. For example, the data may be read from host system 10 (e.g., the host memory 120) through the connection interface circuit 230, and the read data may be written into the rewritable non-volatile memory module 220 through the memory interface control circuit 213. As another example, the data may be read from the rewritable non-volatile memory module 220 through the memory interface control circuit 213, and the read data may be written into the host system 10 (e.g., the host memory 120) through the connection interface circuit 230. Functions of the data transfer management circuit 212 in the invention are described in more detail with reference to various drawings and embodiments.

The memory interface control circuit 213 is configured to receive instruction of the processor 211 and perform data writing (or, programming) and reading operations for the rewritable non-volatile memory module 220 together with the data transfer management circuit 212. The memory interface control circuit 213 may also perform an erasing operation for the rewritable non-volatile memory module 220.

For instance, the processor 211 may execute a write command sequence to instruct the memory interface control circuit 213 to write the data into the rewritable non-volatile memory module 220; the processor 211 may execute a read command sequence to instruct the memory interface control circuit 213 to read the data from the rewritable non-volatile memory module 220; the processor 211 may execute an erase command sequence to instruct the memory interface control circuit 213 to perform the erasing operation for the rewritable non-volatile memory module 220. Each of the write command sequence, the read command sequence and the erase command sequence may include one or more program codes or command codes, which are configured to perform the corresponding operations of writing, reading and erasing for the rewritable non-volatile memory module 220. In an embodiment, the processor 211 may further give other command sequences to the memory interface control circuit 213 in order to perform the corresponding operations for the rewritable non-volatile memory module 220.

In addition, data to be written to the rewritable non-volatile memory module 220 is converted into a format acceptable by the rewritable non-volatile memory module 220 through the memory interface control circuit 213. Specifically, when the processor 211 intends to access the rewritable non-volatile memory module 220, the processor 211 sends the corresponding command sequences to the memory interface control circuit 213 in order to instruct the memory interface control circuit 213 to perform the corresponding operations. For example, the command sequences may include the write command sequence which instructs to write data, the read command sequence which instructs to read data, the erase command sequence which instructs to erase data, and other corresponding command sequences for instructing to perform various memory operations (e.g., changing read voltage levels or performing a garbage collection procedure). The command sequences may include one or more signals, or data from the bus. The signals or the data may include command codes and program codes. For example, information such as identification codes and memory addresses are included in the read command sequence.

In the present embodiment, the memory interface control circuit 213 further identifies states of logical blocks assigned to the rewritable non-volatile memory module 220. The memory interface control circuit 213 may also identify states of physical blocks of the rewritable non-volatile memory module 220. More specifically, after the memory interface control circuit 213 sends read/write requests to the rewritable non-volatile memory module 220 according to read/write commands, the memory interface control circuit 213 identifies (determines) whether the storage unit (e.g., the physical block or a physical page, or the corresponding logical block or a logical page) of the rewritable non-volatile memory module 220 is in a readiness state. For instance, the memory interface control circuit 213 identifies whether the physical blocks corresponding to the read/write commands are ready to data transfer, and when the memory interface control circuit 213 identifies that one physical block among the physical blocks corresponding to the read/write commands is ready for the data transfer, the memory interface control circuit 213 can send a state report indicating that the logical block mapped to said physical block is in the readiness state. In other words, the memory interface control circuit 213 determines whether the state of the logical block is in the readiness state by determining whether the physical blocks mapped by the logical block is ready for the data transfer. The memory interface control circuit 213 can actively determine whether the state of the corresponding physical block is ready for the data transfer, and may also passively receive the state report of the corresponding physical block from the rewritable non-volatile memory module 220. The invention is not intended to limit how the memory interface control circuit 213 identifies whether the physical block/logical block for the data access is in the readiness state.

The rewritable non-volatile memory module 220 is coupled to the storage controller 210 e.g., the memory interface control circuit 213) and configured to store data written from the host system 10. The rewritable non-volatile memory module 220 may be a SLC (Single Level Cell) NAND flash memory module (i.e., a flash memory module capable of storing one bit in one memory cell), a MLC (Multi Level Cell) NAND flash memory module (i.e., a flash memory module capable of storing two bits in one memory cell), a TLC (Triple Level Cell) NAND flash memory module (i.e., a flash memory module capable of storing three bits in one memory cell), other flash memory modules or any memory module having the same features. The memory cells in the rewritable non-volatile memory module 220 are disposed in an array.

In the present embodiment, the memory cells of the rewritable non-volatile memory module 220 can constitute a plurality of physical programming units, and the physical programming units can constitute a plurality of physical blocks (also known as physical erasing units). Specifically, the memory cells on the same word line (or the same word line layer) can constitute one or more of the physical programming units. If each of the memory cells may be used to store two or more bits, the physical programming units on the same word line (or the same word line layer) may be at least classified into one lower physical programming unit and one upper physical programming unit.

In an embodiment, if each of the memory cells may be used to store two bits, the physical programming units on the same word line (or the same word line layer) may be classified into one lower physical programming unit and one upper physical programming unit. For instance, a least significant bit (LSB) of one memory cell belongs to the lower physical programming unit, and a most significant bit (MSB) of one memory cell belongs to the upper physical programming unit. Generally, a writing speed of the lower physical programming unit is higher than a writing speed of the upper physical programming unit, and/or a reliability of the lower physical programming unit is higher than a reliability of the upper physical programming unit. In an embodiment, if each of the memory cells may be used to store three bits, the physical programming units on the same word line (or the same word line layer) may be classified into one lower physical programming unit, one upper physical programming unit and one extra physical programming unit. For example, a least significant bit (LSB) one memory cell belongs to the lower physical programming unit, a center significant bit (CSB) of one memory cell belongs to the upper physical programming unit, and a most significant bit (MSB) of one memory cell belongs to the extra physical programming unit.

In the present embodiment, the physical block is used as the storage unit for writing (programming) data. The physical block may also be referred to as the physical erasing unit or a physical unit. The physical erasing unit is the minimal unit for erasing. Namely, each physical erasing unit contains the least number of memory cells to be erased together. Each of the physical blocks has a plurality of physical programming units. The physical programming units are the physical page or a physical sector. When the physical programming units are the physical page, the physical programming units usually include a data bit area and a redundancy bit area. The data bit area includes multiple physical sectors configured to store user data, and the redundant bit area is configured to store system data (e.g., an error correcting code).

However, the invention is not limited thereto. For example, in another embodiment, the data transfer method described in the present embodiment may also be modified and applied to the rewritable non-volatile memory module 220 in which the physical programming unit is a storage unit for writing data.

In an embodiment, the storage controller 210 manages the memory cells in the rewritable non-volatile memory module 220 based on the physical unit. For example, in the following embodiments, examples in which one physical block serves as one physical unit are provided. However, in another embodiment, one physical unit may also refer to a composition with any number of memory cells, depending on practical requirements. Further, it should be understood that, when the storage controller 211 groups the memory cells (or the physical units) in the rewritable non-volatile memory module 220 for the corresponding management operations, the memory cells (or the physical units) are logically grouped but their actual locations are not changed.

The storage controller 210 assigns a plurality of logical units for mapping to a plurality of physical units of the rewritable non-volatile memory module 220 for storing the user data, and the host system 10 accesses the user data stored in the physical units for storing the user data through the logical units. Herein, each of the logical units may be constituted by one or more logic addresses. For example, the logic unit may be a logical block, a logical page or a logical sector. One logical unit may be mapped to one or more physical units, where the physical unit may be one or more physical addresses, one or more physical sectors, one or more physical programming units, or one or more physical erasing units. In the present embodiment, the logical unit is the logical block.

For instance, the storage controller 210 establishes a logical to physical address mapping table and a physical to logical address mapping table to record a mapping relation between the logical unit (e.g., the logical block, the logical page or the logical sector) assigned to the rewritable non-volatile memory module 220 and the physical unit (e.g., the physical erasing unit, the physical programming unit or the physical sector). In other words, the storage controller 210 may look up for the physical unit mapped to one logical unit by using the logical to physical address mapping table, and the storage controller 210 may look up for the logical unit mapped to one physical unit by using the physical to logical address mapping table. Nonetheless, the technical concept for the mapping relation between the logical unit and the physical unit is a well-known technical means in the field, which is not repeated hereinafter.

In an embodiment, the storage controller 210 further includes a buffer memory and a power management circuit. The buffer memory is coupled to the processor 211 and configured to temporarily store data and commands from the host system 10, data from the rewritable non-volatile memory module 220 or other system data for managing the storage device 20. The power management circuit is coupled to the processor 211 and configured to control power of the storage device 20.

In the present embodiment, a data transfer command corresponding to the NVMe interface standard is also known as an NVMe I/O command. Furthermore, the NVMe I/O command may also be divided into an NVMe I/O read command and an NVMe I/O write command. Main fields in a command description of the NVMe I/O command are a starting logical block address (SLBA), a number of logical blocks (NLB), a first physical region page pointer (Physical Region Page Pointer 1; PRP1) and a second physical region page pointer (Physical Region Page Pointer 2; PRP2).

The starting logical block address is configured to indicate an address (at the maximum of 64-bit). Said address is an address of a foremost (first) logical block sorted within a range of addresses of the logical blocks for the data transfer. The number of logical blocks is configured to indicate a total number of the logical blocks within the range of addresses of the logical blocks for the data transfer.

It should be noted that, in the present embodiment, when a value of the number of logical blocks is “0”, it means that the number of logical blocks is “1”. In other words, the total number of the logical blocks within the range of addresses of the logical blocks for the data transfer is the value of the number of logical blocks plus one.

The range of (addresses of) the logical blocks for the data transfer may be obtained with the combination of the starting logical block address and the number of logical blocks. For instance, it is assumed that the rewritable non-volatile memory module 220 is currently assigned with six logical blocks LBA(0) to LBA(5). When the NVMe I/O command (e.g., with the command description in which SLBA=“LBA(0)” and NLB=“2”) is received, it can be known that the starting logical block address corresponds to the logical block LBA(0), the logical block LBA(0) is the foremost logical block sorted in the logical blocks to be accessed, and the number of logical blocks indicates that the total number of the logical blocks to be accessed is three. In other words, the NVMe I/O command in this example may represent the data access (transfer) with the logical blocks LBA(0) to LBA(2) as targets.

The first physical region page pointer and the second physical region page pointer are configured to indicate memory page addresses in the host memory. The memory page addresses are configured to indicate source (corresponding to the write command)/destination (corresponding to the read command) of the data access. Detailed specification for each field in the command description of the NVMe interface standard belongs to the prior art, which is not repeated hereinafter.

The data transfer method corresponding to the data transfer commands of the NVMe interface standard provided in the embodiments of the invention will be described below with reference to FIG. 1 and the subsequent drawings.

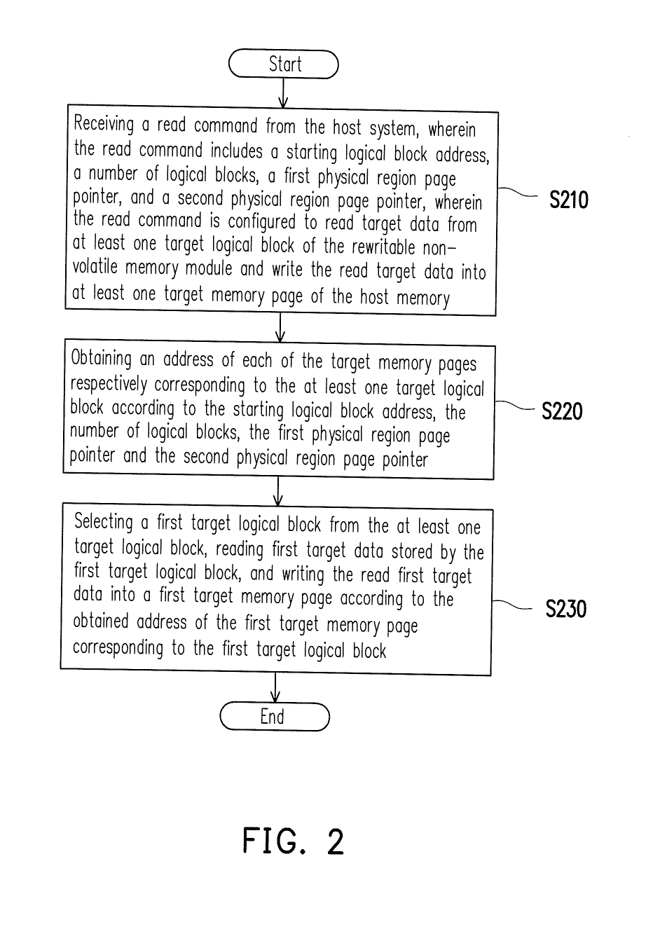

FIG. 2 is a flowchart illustrating a data reading method according to an embodiment of the invention. In the present embodiment, referring to FIG. 1 and FIG. 2 together, in step S210, the processor 211 receives a read command from the host system 10, wherein the read command includes a starting logical block address, a number of logical blocks, a first physical region page pointer, and a second physical region page pointer, wherein the read command is configured to instruct reading target data from at least one target logical block of a rewritable non-volatile memory module and write the read target data into at least one target memory page of a host memory.

Specifically, the host system 10 gives a plurality of read commands or write commands to the storage controller 210 of the storage device 20 in order to access the data in the storage device 20. After receiving (or reading) the read/write commands given by the host system 10, the storage controller 210 performs the data reading/writing operation for the rewritable non-volatile memory module 220 in the storage device 20.

For instance, in an embodiment, it is assumed that the processor 110 of the host system 10 divides the host memory 120 into a temporary data area and a command queue area, and the storage controller 210 further includes a command management unit. The command management unit is, for example, a circuit element having a command buffer, a command status register and a command fetching circuit. The host system 10 stores the read commands or the write commands to the command queue area of the host memory 120, and the command fetching circuit reads the read/write commands from the command queue area and stores the read commands to the command buffer. The processor 211 may select the command to be processed according to a firmware or software predetermined rule. Next, the processor 211 executes the selected command, and instructs the memory interface control circuit 213 to perform the corresponding data transfer operation for the rewritable non-volatile memory module 220 according to the selected command (e.g., the NVMe I/O command). However, the invention is not limited only to aforementioned method in which the storage controller 210 receives the read/write commands from the host system 10.

It should be noted that, in an embodiment, the storage controller 210 may also prefetch data/information corresponding to the read/write commands in the temporary data area of the host memory 120.

As described above, the read command is, for example, the NVMe I/O read command, which includes the starting logical block address, the number of logical blocks, the first physical region page pointer, and the second physical region page pointer. Among them, the range of addresses of (at least one) logical block (also known as a target logical block) to be read from the rewritable non-volatile memory module 220 may be obtained through the starting logical block address and the number of logical blocks; and at least one memory page address (e.g., a first memory page address indicated by the first physical region page pointer and a second memory page address indicated by the second physical region page pointer) may be obtained through the first physical region page pointer and the second physical region page pointer. Further, the storage controller 210 may store data (also known as the target data) read from the target logical block through the first memory page address and the second memory page address. In other words, according to instruction of the read command, the storage controller 210 can read the target data from the at least one target logical block of the rewritable non-volatile memory module and write the read target data into the at least one target memory page of the host memory.

In step S220, the processor 221 instructs the data transfer management circuit 212 to obtain an address of each of the target memory pages respectively corresponding to the at least one target logical block according to the starting logical block address, the number of logical blocks, the first physical region page pointer, and the second physical region page pointer.

Specifically, the data transfer management circuit 212 calculates information for the data transfer according to the starting logical block address, the number of logical blocks, the first physical region page pointer, and the second physical region page pointer, and identifies the address of the memory page (also known as the target memory page) in the host memory corresponding to the target logical blocks among (within the range of) the target logical blocks. As such, in the subsequent step, the target data stored by the target logical block may be read and the target data may then be written into the addresses of the corresponding target memory pages. The calculating method will be described in more details in the following embodiments.

In step S230, the memory interface control circuit 213 selects a first target logical block from the at least one target logical block and reads first target data stored by the first target logical block, and the data transfer management circuit 212 writes the read first target data into a first target memory page according to the obtained address of the first target memory page corresponding to the first target logical block.

Specifically, the memory interface control circuit 213 determines whether each target logical block among the target logical blocks is in a readiness state, and selects the target logical blocks in the readiness state among the target logical blocks to be the first target logical block. As described above, the readiness state is configured to indicate that the logical block in the readiness state is ready to be transferred. For instance, in an embodiment, each logical block has a mark (or a flag), which is configured to indicate whether the corresponding logical block is currently in a busy state. For example, when the physical block corresponding to one logical block is undergoing programming, reading, erasing or other management operations, the mark of said logical block is recorded as “a first state” (e.g., with a bit value being “1”) to indicate that said logical block is currently busy and unable to participate in other operations (e.g., in the busy state). Next, if the memory interface control circuit 213 identifies that the mark of one logical block is recorded as “a second state” (e.g., with the bit value being “0”), the memory interface control circuit 213 can determine that said logical block is currently not in the busy state (i.e., the memory interface control circuit 213 determines that said logical block is in the readiness state).

In the present embodiment, it is possible that the selected first target logical block is not selected according to a sequential order of all the logical blocks in the target logical blocks. The memory interface control circuit 213 can directly select a target logical block to be the first target logical block according to whether the logical block is in the readiness state. Accordingly, the data of the logical block ready for the data transfer may be read in real time.

For instance, after the first target logical block is selected (determined), the memory interface control circuit 213 reports the first target logical block back to the data transfer management circuit 212. Meanwhile, the memory interface control circuit 213 reads the data stored by (in) the first target logical block (e.g., the memory interface control circuit 213 reads the data from the physical block mapped to the first target logical block). The data read from the first target logical block is also known as the first target data. It should be noted that, the number of the first target logical blocks reported each time is one.

For each first target logical block being reported, the data transfer management circuit 212 can identify the address of the target memory page (also known as the first target memory page) corresponding to the first target logical block. The data transfer management circuit 212 writes the first target data read through the memory interface control circuit 213 into the first target memory page according to the address of the first target memory page.

Steps in the flowchart of FIG. 2 will be described in more details below with reference to the first to third embodiments.

### First Embodiment

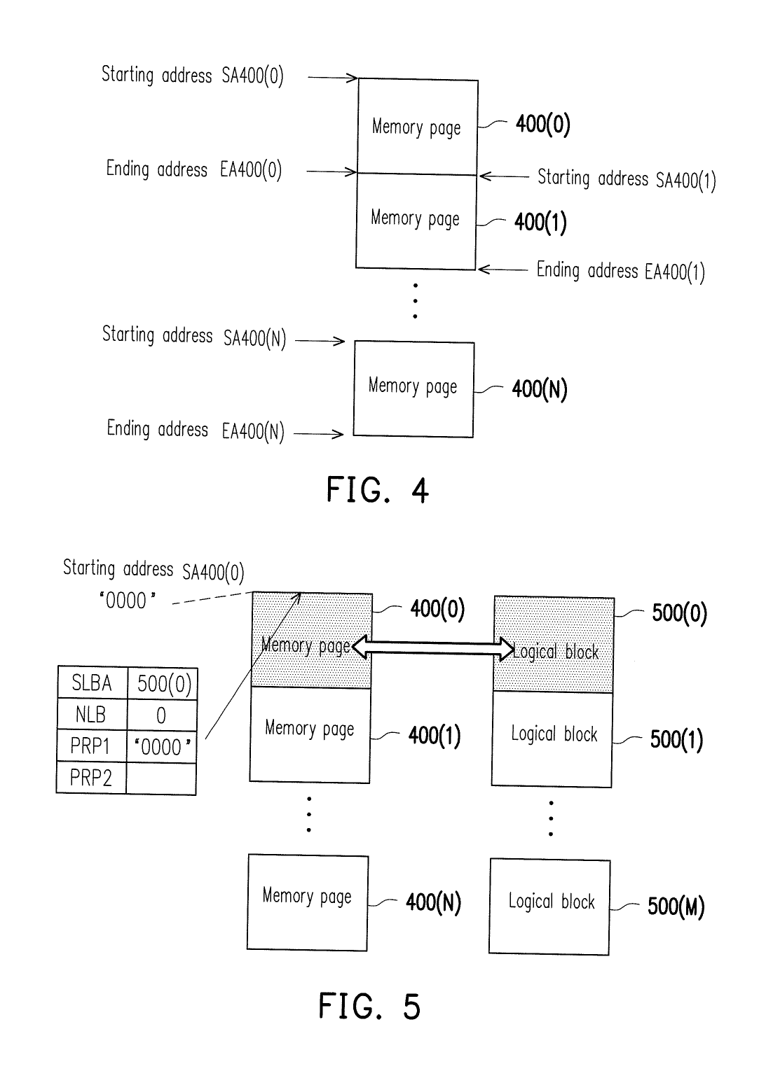

FIG. 4 is a schematic diagram illustrating a memory page according to the first embodiment of the invention. Referring to FIG. 4, it is assumed that the host memory 120 is divided into a plurality of memory pages 400(0) to 400(N). “N” is, for example, a positive integer being 15. Among them, as shown in the drawing, the memory pages 400(0), 400(1), . . . , 400(N) have the starting addresses SA400(0), SA400(1), . . . , SA400(N) and the ending addresses EA400(0), EA400(1), EA400(N), respectively. If the memory pages are addressed in hexadecimal notation, the starting address SA400(0) is “0000”; the starting address SA400(1) is “1000”; and the starting address SA400(N) is “F000”. The ending address EA400(0) is “0FFF”; the ending address EA400(1) is “1FFF”; and the ending address EA400(N) is “FFFF”. In this example, a size of the memory pages 400(0) to 400(N) is 4096 bytes.

FIG. 5 is a flowchart illustrating a data transfer according to the first embodiment of the invention. Referring to FIG. 5, the memory pages 400(0) to 400(N) are identical to the above, which are not repeated hereinafter. Further, the rewritable non-volatile memory module 220 is assigned with logical blocks 500(0) to 500(M), where “M” is a positive integer with a size configured based on demands of the manufacturers. For illustrative convenience, in the present embodiment, a size of (each of) the logical block is 4096 bytes.

As shown by the left table in FIG. 5, it is assumed in the read command received from the host system 10, a value of the starting logical block address (SLBA) is “500”, a value of the number of logical blocks is “0”, and a value of the first physical region page pointer is “0000”.

In the present embodiment, the data transfer management circuit 212 determines whether use of the second physical region page pointer (PRP2) is required according to a size of each logical block (logical block size; LBS) in the logical blocks 500(0) to 500(M), a size of each memory page (memory page size; MPS) in the memory pages 400(0) to 400(N), the starting logical block address, the number of logical blocks, and the first physical region page pointer (PRP1).

Specifically, the data transfer management circuit 212 calculates a size of the target data according to the size of each of the logical blocks and the number of logical blocks. For example, in this example, the size of each of the logical blocks is 4096 bytes, and the number of logical blocks is one (NLB=“0”). Accordingly, the size of the target data is 4096 bytes (e.g., 4096 (bytes)*1=4096 (bytes)).

Next, the data transfer management circuit 212 determines the ending address (e.g., “0FFF”) of the memory page (e.g., the memory page 400(0)) to which the first memory page address (e.g., “0000”) belongs according to the size of each of the memory pages and the first physical region page pointer, and uses a space between the ending address and the first memory page address as an initial memory page space (marked in gray scale). The data transfer management circuit 212 identifies a size of the initial memory page space (e.g., 0FFF″-“0000”+1=“1000” (in hexadecimal)=4096 (in decimal)).

In the present embodiment, the data transfer management circuit 212 determines whether the size of the target data is greater than the size of the initial memory page space. The data transfer management circuit 212 determines that use of the second physical region page pointer (PRP2) is not required if the size of the target data is not greater than the size of the initial memory page space. In this example, the sizes of the target data and the initial memory page space are equal (to 4096 bytes). Therefore, the initial memory page space corresponding to the first memory page address indicated by the first physical region page pointer (PRP1) has sufficient space for storing the target data. Accordingly, it is not required to use information of the second memory page address indicated by the second physical region page pointer (PRP2) to determine other memory pages usable for storing the target data.

On the other hand, the data transfer management circuit 212 determines that use of the second physical region page pointer is required if the size of the target data is greater than the size of the initial memory page space. In other words, the data transfer management circuit 212 obtains the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required. Details regarding operations above will be described below with reference to the second and third embodiments.

Referring back to FIG. 5, the data transfer management circuit 212 obtains the address of each of the target memory pages respectively corresponding to the at least one target logical block according to the size of each of the logical blocks, the size of each of the memory pages, the starting logical block address, the number of logical blocks, and the first physical region page pointer if use of the second physical region page pointer is not required. In this example, the target logical block to be read as instructed by the read command is the logical block 500(0). Also, according to the first memory page address indicated by the first physical region page pointer, it can be known that the target data stored by the logical block 500(0) will be written starting from the starting address SA400(0) being “0000” in the memory page 400(0) of the host memory 120. In other words, in this example, the address of the target memory page corresponding to the logical block 500(0) obtained by the data transfer management circuit 212 is “0000” (e.g., step S220).

Next (e.g., step S230), in response to the logical block 500(0) identified as in the readiness state by the memory interface control circuit 213, the memory interface control circuit 213 selects the logical block 500(0) to be the first target logical block and reads the target data (e.g., the first target data) stored by the logical block 500(0), and the data transfer management circuit 212 writes the read target data into the memory page 400(0) of the host memory 120 (i.e., the first target memory page) starting from the memory page address “0000” (i.e., the address of the first target memory page).

### Second Embodiment

Hardware elements used in the second embodiment are identical to those of the first embodiment. Settings of the logical blocks 500(0) to 500(M) assigned to the rewritable non-volatile memory module 220 and settings of the memory pages 400(0) to 400(N) in the second embodiment are also identical to those (e.g., the values of LBS and MPS) of the first embodiment, which are not repeated hereinafter. The second embodiment is different from the first embodiment in the value of the first physical region page pointer (PRP1). Further, in the second embodiment, the data transfer management circuit 212 determines that use of the second physical region page pointer (PRP2) is required.

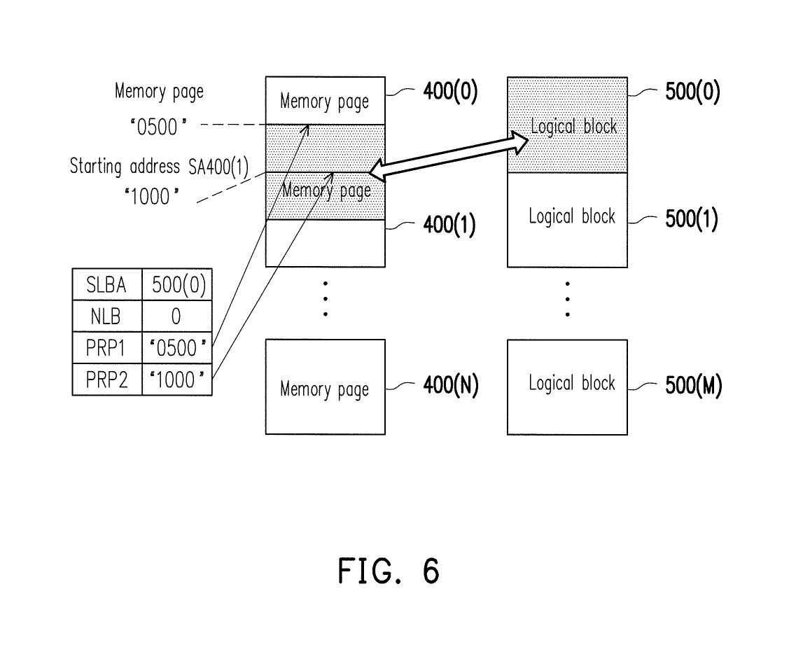

FIG. 6 is a flowchart illustrating a data transfer according to the second and fifth embodiments of the invention.

Referring to FIG. 6, as shown by the left table in FIG. 6, it is assumed in the read command received from the host system 10, the value of the starting logical block address (SLBA) is “500(0)”, the value of the number of logical blocks (NLB) is “0”, the value of the first physical region page pointer (PRP1) is “0500”, and a value of the second physical region page pointer (PRP2) is “1000”.

In the present embodiment, according to aforesaid read command, it can be known that the target logical block is the logical block 500(0) and the size of the target data is 4096 bytes (e.g., 4096 (bytes)*1=4096 (bytes)). The data transfer management circuit 212 determines the ending address (e.g., “0FFF”) of the memory page (e.g., the memory page 400(0)) to which the first memory page address (e.g., “0500”) belongs, and uses a space between the ending address and the first memory page address as the initial memory page space (marked in gray scale). The data transfer management circuit 212 identifies a size of the initial memory page space to be 2816 bytes (e.g., “0FFF”−“0500”+1=“B00” (in hexadecimal)=2816 (in decimal)).

Next, the data transfer management circuit 212 determines whether the size of the target data is greater than the size of the initial memory page space. In this example, the size of the target data is greater than the size of the initial memory page space (4096>2816). Therefore, the data transfer management circuit 212 determines that use of the second physical region page pointer (PRP2) is required. In other words, the initial memory page space has insufficient space for storing all the target data. The data transfer management circuit 212 requires information of the second memory page address indicated by the second physical region page pointer (PRP2) to determine other memory pages usable for storing the (remaining) target data.

In this example, the target logical block to be read as instructed by the read command is the logical block 500(0). Also, according to the first memory page address (e.g., “0500”) indicated by, the first physical region page pointer, it can be known that the target data stored by the logical block 500(0) will be written starting from the memory page address being “0500” in the memory page 400(0) of the host memory 120. Further, after the initial memory page space is fully written, according to the second memory page address (e.g., “1000”) indicated by the second physical region page pointer, the remaining target data is then written into the memory page 400(1) of the host memory 120 starting from the second memory page address being “1000” (e.g., the starting address SA400(1) shown in FIG. 6). In other words, in this example, the addresses of the target memory pages corresponding to the logical block 500(0) obtained by the data transfer management circuit 212 are sequentially “0500” and “1000” (e.g., step S220).

Next (e.g., step S230), in response to the logical block 500(0) identified as in the readiness state by the memory interface control circuit 213, the memory interface control circuit 213 selects the logical block 500(0) to be the first target logical block and reads the target data (e.g., the first target data) stored by the logical block 500(0), and the data transfer management circuit 212 writes the read target data into the memory page 400(0) of the host memory 120 (i.e., the first target memory page) starting from the memory page address “0500” (i.e., the address of the first target memory page). Then, after the target data is written into the memory page 400(0), the remaining target data (with a size being 4096−2816=1280 bytes) which is not yet written into the host memory 120 is written starting from the starting address SA400(1) of the memory page 400(1). It should be noted that, a gray-scale area of the memory page in FIG. 6 is a storage area of the target data, where a starting memory page address of the storage area (destination) of the target data is “0500”, and an ending memory page address of the storage area of the target data is “14FF”. The ending memory page address of the storage area of the target data may be obtained according to the size of the remaining target data and the second memory page address indicated by the second physical region page pointer (PRP2). For example, the size of the remaining target data is 1280 bytes, where 1280 may be converted into “500” in hexadecimal. Next, in hexadecimal notation, a value obtained from the second memory page address (e.g., “1000”) plus the size of the remaining target data (e.g., “500”) minus 1 is the ending memory page address (e.g., “14FF”).

### Third Embodiment

Hardware elements used in the third embodiment are identical to those of the first embodiment. Settings of the logical blocks 500(0) to 500(M) assigned to the rewritable non-volatile memory module 220 and settings of the memory pages 400(0) to 400(N) in the third embodiment are also identical to those (e.g., the values of LBS and MPS) of the first embodiment, which are not repeated hereinafter. The third embodiment is different from the first and second embodiments in that, the data transfer management circuit 212 determines that use of the second physical region page pointer (PRP2) is required in the third embodiment, where information of the second memory page address indicated by the second physical region page pointer (PRP2) indicates a list starting address of a physical region page pointer list (PRP list).

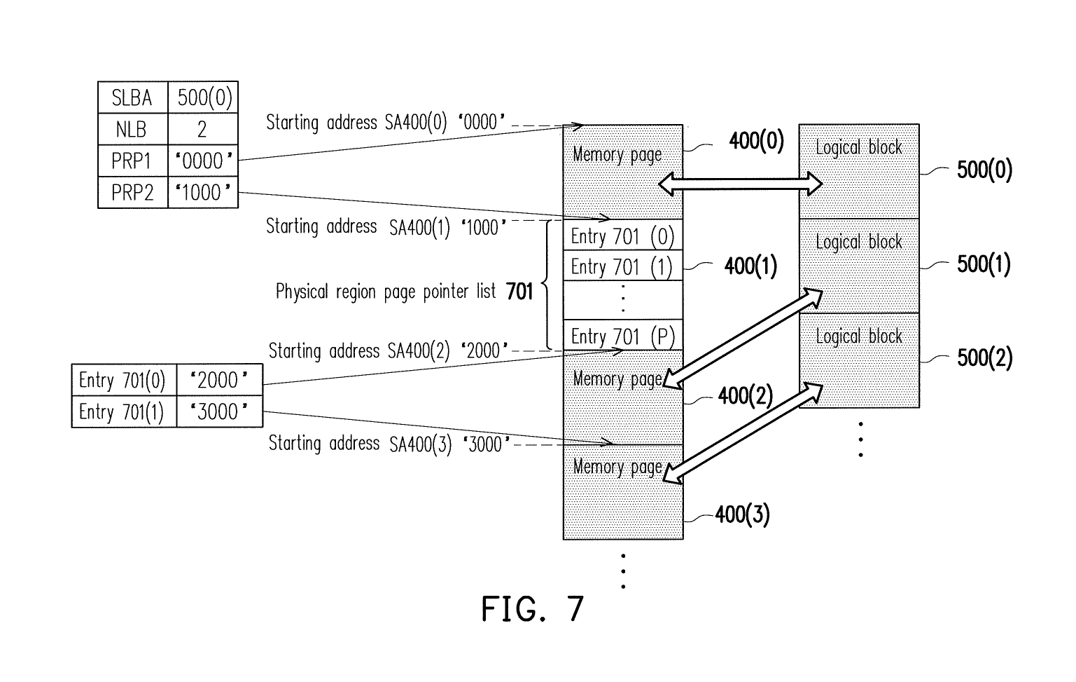

FIG. 7 is a flowchart illustrating a data transfer according to the third and sixth embodiments of the invention.

Referring to FIG. 7, as shown by the left table in FIG. 7, it is assumed in the read command received from the host system 10, the value of the starting logical block address (SLBA) is “500(0)”, the value of the number of logical blocks (NLB) is “2”, the value of the first physical region page pointer (PRP1) is “0000”, and the value of the second physical region page pointer (PRP2) is “1000”.

In the present embodiment, according to aforesaid read command, it can be known that (the range of) the target logical blocks is the logical blocks 500(0) to 500(2) and the size of the target data is 12288 bytes (e.g., 4096 (bytes)*3=12288 (bytes)). The data transfer management circuit 212 determines the ending address (e.g., “0FFF”) of the memory page (e.g., the memory page 400(0)) to which the first memory page address (e.g., “0000”) belongs, and uses a space between the ending address and the first memory page address as the initial memory page space. The data transfer management circuit 212 identifies a size of the initial memory page space to be 4096 bytes (e.g., “0FFF”−“0000”+1=“1000” (in hexadecimal)=4096 (in decimal)).

Next, the data transfer management circuit 212 determines whether the size of the target data is greater than the size of the initial memory page space. In this example, the size of the target data is greater than the size of the initial memory page space (12288>4096). Therefore, the data transfer management circuit 212 determines that use of the second physical region page pointer (PRP2) is required.

Next, after determining that use of the second physical region page pointer (PRP2) is required, the data transfer management circuit 212 determines whether the information of the second memory page address indicated by the second physical region page pointer (PRP2) is the list starting address of the physical region page pointer list (PRP list). Specifically, after the target data is written into the initial memory page space, if the size of the remaining target data is greater than the size of one memory page, use of multiple memory pages is required to store the remaining target data. In this case, the second memory page address of the second physical region page pointer (PRP2) is used to indicate the list starting address of one physical region page pointer list (PRP list). The physical region page pointer list includes a plurality of entries. Each entry among the entries records the starting address of one memory page. It should be noted that, if the size of the remaining target data is not greater than the size of one memory page, the data transfer management circuit 212 identifies that the second memory page address of the second physical region page pointer is not the list starting address of the physical region page pointer list (PRP list) but the starting address of one memory page. For example, in the second embodiment above, other part of the target data not stored in the initial memory page space can be stored simply by using one memory page. Therefore, the second memory page address of the second physical region page pointer in the second embodiment is not the list starting address of the physical region page pointer list (PRP list) but the starting address of one memory page.

More specifically, the data transfer management circuit 212 calculates a difference obtained from the size of the target data minus the size of the initial memory page space, and determines whether the difference is greater than the size of one memory page. The difference may also represent the remaining target data (not yet stored in the host memory) after the initial memory page space is fully written. If the difference is greater than the size of one memory page, the data transfer management circuit 212 then identifies the second memory page address of the second physical region page pointer as the list starting address of the physical region page pointer list (PRP list) since the physical region page pointer list is required to record the starting addresses of two or more memory pages for storing the remaining target data. It should be noted that, the list starting address indicates the starting address of the first one (foremost) entry (e.g., an entry 701(0)) in the physical region page pointer list, and the list starting address does not have to be the starting address of the memory page.

In the present embodiment, the data transfer management circuit 212 uses a value of a quotient obtained from the difference divided by the size of the each of the memory pages (MPS) and rounded up to decimal places to be the number of the entries recorded in the physical region page pointer list. In other words, the data transfer management circuit 212 determines how many memory pages (excluding the initial memory page space) are still required for storing the target data, and correspondingly records the starting addresses of the memory pages (excluding the initial memory page space) for storing the target data in sequence into the entries in the physical region page pointer list. A size of each entry may be a space suitable for recording address information, which is not particularly limited in the invention.

It should be noted that, a maximum capacity of each physical region page pointer list is the size of one memory page. In other words, a maximum number of entries recordable by the physical region page pointer list is a quotient obtained from the size of one memory page divided by the size of each entry. The size of each physical region page pointer list is a size of a space between the corresponding list starting address and the ending address of the memory page to which the physical region page pointer list belongs. For example, a physical region page pointer list 701 may include entries 701(0) to 701(P), where P is a positive integer.

In an embodiment, if the number of the memory pages (excluding the initial memory page space) for storing the target data exceeds the maximum number of entries recordable by one physical region page pointer list, the data transfer management circuit 212 identifies that the last entry of said physical region page pointer list is to be used for recording a starting address of (subsequent) another physical region page pointer list. Accordingly, the data transfer management circuit 212 can proceed to obtain the starting addresses of the other memory pages by reading said another physical region page pointer list.

In this example, the target logical blocks to be read as instructed by the read command are the target logical blocks 500(0) to 500(2). Also, according to the first memory page address (e.g., “0000”) indicated by the first physical region page pointer, it can be known that the target data stored by the logical block 500(0) will be written starting from the memory page address being “0000” in the memory page 400(0) of the host memory 120. For the other part of the target data in addition to the target data to be written into the initial memory page space, the data transfer management circuit 212 reads the entries in the physical region page pointer list 701 starting from the second memory page address being“1000” (e.g., the starting address SA400(1) shown in FIG. 7) according to the second memory page address (e.g., “1000”) indicated by the second physical region page pointer, so as to obtain the addresses of the memory pages to which the other part of the target data is to be stored.

In the present embodiment, the size of the target data is a size of three logical blocks (i.e., 12288 bytes). Excluding the part of the target data (with the size of 4096 bytes, stored in the logical block 500(0)) to be written into the initial memory page space, two memory pages are required for storing the other part of the target data (with the size of 8192 bytes, stored in the logical blocks 500(1) and 500(2)). Accordingly, the data transfer management circuit 212 reads the addresses recorded in the entries 701(0) and 701(1) in the physical region page pointer list 701 to obtain the starting addresses of the memory pages corresponding to the logical blocks 500(1) and 500(2) (as shown in FIG. 7, the starting address SA400(2) “2000” and the starting address SA400(3) “3000” recorded in the entries 701(0) and 701(1), respectively), so as to write the target data stored in the logical blocks 500(1) and 500(2) into the memory pages 400(2) and 400(3) of the host memory 120. It is noted that, in the present embodiment, the data transfer management circuit 212 can read the physical region page pointer list 701 stored in the host memory 120 to obtain the address recorded by each entry. It should be noted that, in this example, the physical region page pointer list 701 includes the entry 701(0) and the entry 701(1), that is, a value of “P” is 1.

Based on the above description, in the present embodiment, the addresses of the target memory pages respectively corresponding to the logical blocks 500(0) to 500(2) obtained by the data transfer management circuit 212 are sequentially “0000”, “2000” and “3000” (e.g., step S220). In addition, the data transfer (reading/writing) method provided by the invention is also capable of independently and separately identifying the logical blocks for storing the target data and the corresponding memory pages instead of accessing the target data according to an arrangement sequence of the target logical blocks corresponding to the data read/write commands. The data writing method provided by the invention will be described below with reference to the fourth, fifth and sixth embodiments.

Next (e.g., step S230), in response to one of the logical blocks among the logical blocks 500(0) to 500(2) identified as in the readiness state by the memory interface control circuit 213, the memory interface control circuit 213 selects the logical block in the readiness state to be the first target logical block in order to start the operation of reading the target data. It should be noted that, the logical block first reported as in the readiness state is used in the data transfer operation first.

For instance, as shown in FIG. 7, the logical block 500(0) corresponds to the memory page 400(0); the logical block 500(1) corresponds to the memory page 400(2); the logical block 500(2) corresponds to the memory page 400(3). Here, it is assumed that the logical block 500(1) is the first reported as in the readiness state by the memory interface control circuit 213 (i.e., the logical block 500(1) is the first target logical block). Next, the memory interface control circuit 213 reads the target data (i.e., the first target data) stored in the logical block 500(1), and the data transfer management circuit 212 writes the read target data into the host memory 120 starting from the address “2000” (i.e., the address of the first target memory page) of the memory page 400(2) (i.e., the first target memory page). After writing the target data of the logical block 500(1) into the memory page 400(2), the data transfer management circuit 212 then identifies the logical block 500(0) or the logical block 500(2) subsequently in the readiness state, and performs the corresponding data transfer operation similar to the above, which is not repeated hereinafter.

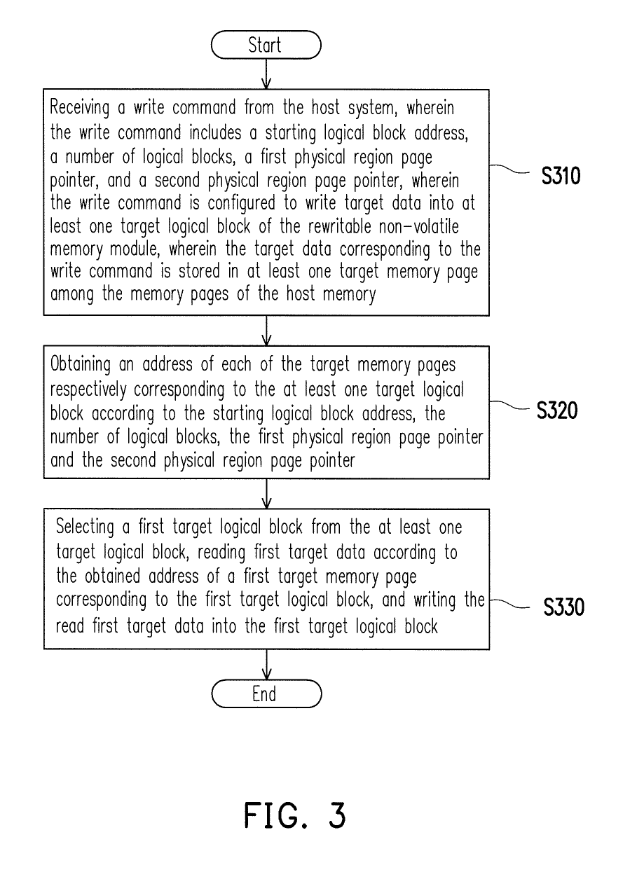

FIG. 3 is a flowchart illustrating a data writing method according to an embodiment of the invention.

In the present embodiment, referring to FIG. 1 and FIG. 3 together, in step S310, the processor 211 receives a write command from the host system 10, wherein the write command includes a starting logical block address, a number of logical blocks, a first physical region page pointer, and a second physical region page pointer, wherein the write command is configured to write target data into at least one target logical block of the rewritable non-volatile memory module, wherein the target data corresponding to the write command is stored in at least one target memory page among the memory pages of the host memory.

As described above, the write command is, for example, the NVMe I/O write command, which includes the starting logical block address, the number of logical blocks, the first physical region page pointer, and the second physical region page pointer. Among them, a range of addresses of (at least one) logical block (also known as a target logical block) to be written into the rewritable non-volatile memory module 220 may be obtained through the starting logical block address and the number of logical blocks; and at least one memory page address (e.g., a first memory page address indicated by the first physical region page pointer and a second memory page address indicated by the second physical region page pointer) may be obtained through the first physical region page pointer and the second physical region page pointer. Further, the storage controller 210 may read the data (also known as target data, which is to be written into the target logical block) corresponding to the write command through the first memory page address and the second memory page address, and write said data into the corresponding target logical block. In other words, according to instruction of the write command, the storage controller 210 can read the target data from at least one target memory page of the host memory 120 and write the read target data into at least one target logical block in the rewritable non-volatile memory module 220.

In step S320, the processor 221 instructs the data transfer management circuit 212 to obtain an address of each of the target memory pages respectively corresponding to the at least one target logical block according to the starting logical block address, the number of logical blocks, the first physical region page pointer, and the second physical region page pointer. This step is similar to step S220, which is not repeated hereinafter.

In step S330, the memory interface control circuit 213 selects a first target logical block from the at least one target logical block, and the data transfer management circuit 212 reads the first target data according to the obtained address of the first target memory page corresponding to the first target logical block, and writes the read first target data into the first target logical block.

Specifically, as described above, the memory interface control circuit 213 determines whether a state of each target logical block among the target logical blocks is in a readiness state, and selects the target logical blocks in the readiness state among the target logical blocks to be the first target logical block. The readiness state has been described in detail in the foregoing embodiment, which is not repeated hereinafter. In the present embodiment, it is possible that the selected first target logical block is not selected according to a precedence of all the logical blocks in the target logical blocks. The memory interface control circuit 213 can directly select the target logical block to be the first target logical block according to whether the logical block is in the readiness state. Accordingly, the data of the logical block ready for the data transfer may be written in real time.

For instance, after the first target logical block is selected (determined), the memory interface control circuit 213 reports the first target logical block back to the data transfer management circuit 212 to inform that the first target logical block is ready to be transferred. For each first target logical block being reported, the data transfer management circuit 212 can identify the address of the target memory page (also known as the first target memory page) corresponding to the first target logical block, and accordingly read the first target data from the first target memory page. Next, the data transfer management circuit 212 writes the read first target data into the first target logical block through the memory interface control circuit 213 (e.g., the memory interface control circuit 213 writes the first target data into the physical block mapped by the first target logical block). It should be noted that, the number of the first target logical blocks reported each time is one.

Steps in the flowchart of FIG. 3 will be described in more details below with reference to the fourth, fifth and sixth embodiments. The fourth, fifth and sixth embodiments are similar to the first, second and third embodiments, respectively, and are described also using the FIG. 5, FIG. 6 and FIG. 7, respectively. Hardware elements and drawings identical to those in the first, second and third embodiments are not repeated hereinafter. The following embodiments merely describe the differences in processing the write command (e.g., the fourth, fifth and sixth embodiments) and the read command (e.g., the first, second and third embodiments) in the data transfer method provided by the invention.

### Fourth Embodiment

Hardware elements used in the fourth embodiment are identical to those of the first embodiment. Settings of the logical blocks 500(0) to 500(M) assigned to the rewritable non-volatile memory module 220 and settings of the memory pages 400(0) to 400(N) in the fourth embodiment are also identical to those (e.g., the values of LBS and MPS) of the first embodiment, which are not repeated hereinafter. The fourth embodiment is different from the first embodiment in that, the fourth embodiment mainly describes the data transfer method related to the write command (e.g., corresponding to FIG. 3), whereas the first embodiment mainly describes the data transfer method related to the read command (e.g., corresponding to FIG. 2).

Referring to FIG. 5, as shown by the left table in FIG. 5, it is assumed in the write command received from the host system 10, a value of the starting logical block address (SLBA) is “500”, a value of the number of logical blocks is “0”, and a value of the first physical region page pointer is “0000”.

In the present embodiment, the data transfer management circuit 212 determines whether use of the second physical region page pointer (PRP2) is required according to a size of each logical block (logical block size; LBS) in the logical blocks 500(0) to 500(M), a size of each memory page (memory page size; MPS) in the memory pages 400(0) to 400(N), the starting logical block address, the number of logical blocks, and the first physical region page pointer (PRP1).

Specifically, in the present embodiment, the data transfer management circuit 212 determines whether the size of the target data is greater than the size of the initial memory page space. The data transfer management circuit 212 determines that use of the second physical region page pointer (PRP2) is not required if the size of the target data is not greater than the size of the initial memory page space. Detailed calculation method regarding the above has been described in the foregoing embodiment, which is not repeated hereinafter. In this example, the sizes of the target data and the initial memory page space are equal (to 4096 bytes). Therefore, the initial memory page space corresponding to the first memory page address indicated by the first physical region page pointer (PRP1) is already stored with all the target data. Accordingly, the data transfer management circuit 212 determines that it is not required to use information of the second memory page address indicated by the second physical region page pointer (PRP2) to determine (identify) the other memory pages for storing the target data.

Referring back to FIG. 5, the data transfer management circuit 212 obtains the address of each of the target memory pages respectively corresponding to the at least one target logical block according to the size of each of the logical blocks, the size of each of the memory pages, the starting logical block address, the number of logical blocks, and the first physical region page pointer if use of the second physical region page pointer is not required. In this example, the target logical block to be written as instructed by the write command is the logical block 500(0). Also, according to the first memory page address indicated by the first physical region page pointer, it can be known that the target data to be stored to the logical block 500(0) is already stored from the starting address SA400(0) being “0000” in the memory page 400(0) of the host memory 120. In other words, in this example, the address of the target memory page corresponding to the logical block 500(0) obtained by the data transfer management circuit 212 is “0000” (e.g., step S320).

Next (e.g., step S330), in response to the logical block 500(0) identified as in the readiness state by the memory interface control circuit 213, the memory interface control circuit 213 selects the logical block 500(0) to be the first target logical block and reports the same back to the data transfer management circuit 212. Next, the data transfer management circuit 212 identifies the address of the memory page (i.e., the first target memory page) corresponding to the logical block 500(0), and reads the target data (i.e., the first target data) starting from the memory page address “0000” (i.e., the address of the first target memory page). Next, the data transfer management circuit 212 writes the read first target data into the logical block 500(0).

### Fifth Embodiment

Hardware elements used in the fifth embodiment are identical to those of the fourth embodiment. Settings of the logical blocks 500(0) to 500(M) assigned to the rewritable non-volatile memory module 220 and settings of the memory pages 400(0) to 400(N) in the fifth embodiment are also identical to those (e.g., the values of LBS and MPS) of the fourth embodiment, which are not repeated hereinafter. The fifth embodiment is different from the fourth embodiment in the value of the first physical region page pointer (PRP1). Further, in the fifth embodiment, the data transfer management circuit 212 determines that use of the second physical region page pointer (PRP2) is required.

Referring to FIG. 6, as shown by the left table in FIG. 6, it is assumed in the write command received from the host system 10, the value of the starting logical block address (SLBA) is “500(0)”, the value of the number of logical blocks (NLB) is “0”, the value of the first physical region page pointer (PRP1) is “0500”, and the value of the second physical region page pointer (PRP2) is “1000”.

In this example, the size of the target data is greater than the size of the initial memory page space (4096>2816). Therefore, the data transfer management circuit 212 determines that use of the second physical region page pointer (PRP2) is required. In other words, the initial memory page space has insufficient space for storing all the target data. The data transfer management circuit 212 requires information of the second memory page address indicated by the second physical region page pointer (PRP2) to determine the other memory pages for storing the target data.

In this example, the target logical block to be read as instructed by the write command is the logical block 500(0). Also, according to the first memory page address (e.g., “0500”) indicated by the first physical region page pointer, it can be known that the target data to be stored by the logical block 500(0) is already stored from the memory page address being “0500” in the memory page 400(0) of the host memory 120. Further, excluding the target data stored in the initial memory page space, the other part of the target data is stored from the second memory page address (e.g., “1000”) indicated by the second physical region page pointer. In other words, in this example, the addresses of the target memory pages corresponding to the logical block 500(0) obtained by the data transfer management circuit 212 are sequentially “0500” and “1000” (e.g., step S320).

Next (e.g., step S330), in response to the logical block 500(0) identified as in the readiness state by the memory interface control circuit 213, the memory interface control circuit 213 selects the logical block 500(0) to be the first target logical block and reports the same back to the data transfer management circuit 212. Next, the data transfer management circuit 212 identifies the addresses of the memory pages (i.e., the first target memory page) corresponding to the logical block 500(0), and sequentially reads the target data (i.e., the first target data) from the memory page addresses “0500” and “0000”. Next, the data transfer management circuit 212 writes the read first target data into the logical block 500(0).

It should be noted that, a gray-scale area of the memory page in FIG. 6 is a read area of the target data, where a starting memory page address of the read area (source) of the target data is “0500”, and an ending memory page address of the read area of the target data is “14FF”. The ending memory page address of the read area of the target data may be obtained according to the size of the other part of the target data and the second memory page address indicated by the second physical region page pointer (PRP2).

### Sixth Embodiment

Hardware elements used in the sixth embodiment are identical to those of the fourth embodiment. Settings of the logical blocks 500(0) to 500(M) assigned to the rewritable non-volatile memory module 220 and settings of the memory pages 400(0) to 400(N) in the sixth embodiment are also identical to those (e.g., the values of LBS and MPS) of the fourth embodiment, which are not repeated hereinafter. The sixth embodiment is different from the fourth and fifth embodiments in that, the data transfer management circuit 212 determines that use of the second physical region page pointer (PRP2) is required in the sixth embodiment, where information of the second memory page address indicated by the second physical region page pointer (PRP2) indicates a list starting address of a physical region page pointer list (PRP list).

Referring to FIG. 7, as shown by the left table in FIG. 7, it is assumed in the write command received from the host system 10, the value of the starting logical block address (SLBA) is “500(0)”, the value of the number of logical blocks (NLB) is “2”, the value of the first physical region page pointer (PRP1) is “0000”, and the value of the second physical region page pointer (PRP2) is “1000”.

In the present embodiment, according to aforesaid write command, it can be known that (the range of) the target logical blocks is the logical blocks 500(0) to 500(2) and the size of the target data is 12288 bytes (e.g., 4096 (bytes)*3=12288 (bytes)). The data transfer management circuit 212 identifies a size of the initial memory page space to be 4096 bytes (e.g., “0FFF”−“0000”+1=“1000” (in hexadecimal)=4096 (in decimal)).

Next, the data transfer management circuit 212 determines whether the size of the target data is greater than the size of the initial memory page space. In this example, the size of the target data is greater than the size of the initial memory page space (12288>4096). Therefore, the data transfer management circuit 212 determines that use of the second physical region page pointer (PRP2) is required.

Next, after determining that use of the second physical region page pointer (PRP2) is required, the data transfer management circuit 212 determines whether the information of the second memory page address indicated by the second physical region page pointer (PRP2) is the list starting address of the physical region page pointer list (PRP list). Specifically, if the initial memory page space is insufficient for storing all the target data, and the size of the other part of the target data (the target data not stored in the memory page space) is greater than the size of one memory page, it is determined that use of multiple memory pages is required for storing the remaining target data. In this case, the second memory page address of the second physical region page pointer (PRP2) is used to indicate the list starting address of one physical region page pointer list (PRP list). The physical region page pointer list includes a plurality of entries. Each entry among the entries records the starting address of one memory page. It should be noted that, if the difference is not greater than the size of one memory page, the data transfer management circuit 212 identifies that the second memory page address of the second physical region page pointer is not the list starting address of the physical region page pointer list (PRP list) but the starting address of one memory page.

More specifically, the data transfer management circuit 212 calculates a difference obtained from the size of the target data minus the size of the initial memory page space, and determines whether the difference is greater than the size of one memory page. The difference also represents the size of the other part of the target data not stored in the initial memory page space. If the difference is greater than the size of one memory page, the data transfer management circuit 212 then identifies the second memory page address of the second physical region page pointer as the list starting address of the physical region page pointer list (PRP list) since the physical region page pointer list is required to record the starting addresses of two or more memory pages for storing the other part of the target data. Architecture related to the physical region page pointer list has been described in the foregoing embodiment, which is not repeated hereinafter.

It is noted that, while sending the write command, the hot system 10 first writes all the target data corresponding to the write command and the physical region page pointer list corresponding to the target data into the host memory 120.

In this example, the target logical blocks to be written as instructed by the write command are the target logical blocks 500(0) to 500(2). Also, according to the first memory page address (e.g., “0000”) indicated by the first physical region page pointer, it can be known that the target data to be stored to the logical block 500(0) is stored from the memory page address being “0000” in the memory page 400(0) of the host memory 120. Further, excluding the target data stored in the initial memory page space (i.e., the entire memory page 400(0)), the other part of the target data may be obtained according to the entries in the physical region page pointer list 701.

In the present embodiment, the size of the target data is a size of three logical blocks (i.e., 12288 bytes). Excluding the part of the target data (with the size of 4096 bytes, already stored in the memory page 400(0)) already stored in the initial memory page space, two memory pages are required for storing the other part of the target data (with the size of 8192 bytes, to be stored in the two logical blocks 500(1) and 500(2)). Accordingly, the data transfer management circuit 212 reads the addresses recorded in the (two) entries 701(0) and 701(1) in the physical region page pointer list 701 to obtain the starting addresses of the memory pages corresponding to the logical blocks 500(1) and 500(2) (as shown in FIG. 7, the starting address SA400(2) “2000” and the starting address SA400(3) “3000” recorded in the entries 701(0) and 701(1), respectively), so as to write the target data stored in the memory pages 400(2) and 400(3) of the host memory 120 into the logical blocks 500(1) and 500(2). It is noted that, in the present embodiment, the data transfer management circuit 212 can read the physical region page pointer list 701 stored in the host memory 120 to obtain the address recorded by each entry.

Based on the foregoing description, in the present embodiment, the addresses of the target memory pages respectively corresponding to the logical blocks 500(0) to 500(2) obtained by the data transfer management circuit 212 are sequentially “0000”, “2000” and “3000” (e.g., step S320).

Next (e.g., step S330), in response to one of the logical blocks among the logical blocks 500(0) to 500(2) identified as in the readiness state by the memory interface control circuit 213, the memory interface control circuit 213 selects the logical block in the readiness state to be the first target logical block in order to start the operation of writing the target data corresponding to the first target logical block (which is read from the first target memory page corresponding to the first target logical block) into the first target logical block. It should be noted that, the logical block reported as in the readiness state first is used in the data transfer operation first.

For instance, as shown in FIG. 7, the logical block 500(0) corresponds to the memory page 400(0); the logical block 500(1) corresponds to the memory page 400(2); the logical block 500(2) corresponds to the memory page 400(3). Here, it is assumed that the logical block 500(1) is the first reported as in the readiness state by the memory interface control circuit 213 (i.e., the logical block 500(1) is the first target logical block). Next, the data transfer management circuit 212 identifies the memory page 400(2) corresponding to the logical block 500(1), and reads the first target data from the address “2000” (i.e., the address of the first target memory page) of the memory page 400(2) (i.e., the first target memory page).

Next, the data transfer management circuit 212 writes the read first target data into the logical block 500(1). After writing the target data corresponding to the logical block 500(1), the data transfer management circuit 212 then identifies the logical block 500(0) or the logical block 500(2) subsequently in the readiness state, and performs the corresponding data transfer operation similar to the above, which is not repeated hereinafter.

The data writing method provided in the foregoing embodiments is also capable of independently and separately identifying the logical blocks for storing the target data and the corresponding memory pages instead of writing the target data according to an arrangement sequence of the target logical blocks corresponding to the data write commands.

It should be noted that, the logical block as described in the foregoing embodiments may be also be modified into storage unit of other forms (e.g., logical page or logical unit) based on demands of the manufacturers without departing from the spirit of the invention. The target data may be stored in one or more logical blocks. The target data stored in multiple logical blocks, according to the logical blocks stored the target block, may be separately performed data transfer with the corresponding memory pages of the host memory.

It is noted that, in the foregoing embodiments, the size of the logical block is equal to the size of the memory page. However, in other embodiments, the size of the logical block may be less than or greater than the size of the memory page.

Nonetheless, the address of each of the memory pages corresponding to the logical blocks used for storing one target data may be all located according to the read/write commands with reference to the method in the foregoing embodiments.

In summary, the data transfer (reading/writing) method provided in various embodiments of the invention allows the storage controller to non-sequentially and directly access the part of storage units ready for access without spending time waiting for all of the storage units to become ready for access (e.g., part of the target data stored in the logical blocks in the readiness state may be directly accessed so that the part of the target data may be separately accessed rather than start accessing from the first one logical block storing the target data). As such, the storage controller may be prevented from wasting too much time on the process of waiting while reducing the temporary storage area and resources spent for sequential access. Also, the address of the target memory page corresponding to the target logical block may be calculated rapidly through hardware to accelerate the speed of data transfer while reducing loadings on the processor of the storage controller, so as to improve the working efficiency for the storage device and its data transfer operation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data reading method, suitable for reading data from a rewritable non-volatile memory module into a host memory of a host system, wherein the rewritable non-volatile memory module is assigned with a plurality of logical blocks, the host memory has a plurality of memory pages, and the data reading method comprises:
receiving a read command from the host system, wherein the read command comprises a starting logical block address, a number of logical blocks, a first physical region page pointer, and a second physical region page pointer, wherein the read command is configured to read target data from at least one target logical block of the rewritable non-volatile memory module and write the read target data into at least one target memory page of the host memory, wherein the target data is stored starting from a starting logical block in the at least one target logical block, wherein the starting logical block address is configured to indicate an address of the starting logical block, the number of logical blocks is configured to indicate a number of the logical blocks storing the target data in the at least one target logical block, the first physical region page pointer is configured to indicate a first memory page address of the host memory, and the second physical region page pointer is configured to indicate a second memory page address of the host memory;
obtaining an address of each of the target memory pages respectively corresponding to the at least one target logical block according to the starting logical block address, the number of logical blocks, the first physical region page pointer, and the second physical region page pointer; and
selecting a first target logical block from the at least one target logical block, reading first target data stored by the first target logical block, and writing the read first target data into a first target memory page according to the obtained address of the first target memory page corresponding to the first target logical block.

2. The data reading method according to claim 1, wherein the step of selecting the first target logical block from the at least one target logical block comprises:
determining whether each target logical block among the at least one target logical block is in a readiness state, and selecting one target logical block in the readiness state from the at least one target logical block to be the first target logical block, wherein the readiness state is configured to indicate that the logical block in the readiness state is ready to be transferred.

3. The data reading method according to claim 1, wherein the step of obtaining the address of each of the target memory pages respectively corresponding to the at least one target logical block according to the starting logical block address, the number of logical blocks, the first physical region page pointer, and the second physical region page pointer comprises:
determining whether use of the second physical region page pointer is required according to a size of each of the logical blocks, a size of each of the memory pages, the starting logical block address, the number of logical blocks, and the first physical region page pointer;
obtaining the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required; and
obtaining the address of each of the target memory pages respectively corresponding to the at least one target logical block according to the size of each of the logical blocks, the size of each of the memory pages, the starting logical block address, the number of logical blocks, and the first physical region page pointer if use of the second physical region page pointer does is not required.

4. The data reading method according to claim 3, wherein the step of determining whether use of the second physical region page pointer is required according to the size of each of the logical blocks, the size of each of the memory pages, the starting logical block address, the number of logical blocks, and the first physical region page pointer comprises:
calculating a size of the target data according to the size of each of the logical blocks and the number of logical blocks;
determining an ending address of the memory page to which the first memory page address belongs according to the size of each of the memory pages and the first physical region page pointer, and using a space between the ending address and the first memory page address as an initial memory page space; and
determining that use of the second physical region page pointer is required if the size of the target data is greater than a size of the initial memory page space.

5. The data reading method according to claim 4, wherein the step of obtaining the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required comprises:
calculating a difference obtained from the size of the target data minus the size of the initial memory page space;
identifying the second memory page address indicated by the second physical region page pointer as a list starting address of a physical region page pointer list if the difference is greater than the size of each of the memory pages, wherein the physical region page pointer list stores a plurality of entries, wherein each entry among the entries records one memory page address; and
determining the address of each of the target memory pages respectively corresponding to the at least one target logical block according to the initial memory page space and the physical region page pointer list.

6. The data reading method according to claim 5, wherein the step of obtaining the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required further comprises:
identifying the second memory page address indicated by the second physical region page pointer as a starting address of a remaining memory page if the difference is not greater than the size of each of the memory pages; and
determining the address of each of the target memory pages respectively corresponding to the at least one target logical block according to the initial memory page space and the starting address of the remaining memory page.

7. A data writing method, suitable for writing data from a host memory of a host system into a rewritable non-volatile memory module, wherein the rewritable non-volatile memory module is assigned with a plurality of logical blocks, the host memory has a plurality of memory pages, and the data writing method comprises:
receiving a write command from the host system, wherein the write command comprises a starting logical block address, a number of logical blocks, a first physical region page pointer, and a second physical region page pointer, wherein the write command is configured to write target data into at least one target logical block of the rewritable non-volatile memory module, wherein a foremost logical block sorted in the at least one target logical block is a starting logical block, wherein the starting logical block address is configured to indicate an address of the starting logical block, the number of logical blocks is configured to indicate a number of the logical blocks storing the target data in the at least one target logical block, the first physical region page pointer is configured to indicate a first memory page address of the host memory, and the second physical region page pointer is configured to indicate a second memory page address of the host memory, wherein the target data corresponding to the write command is stored in at least one target memory page among the memory pages of the host memory;
obtaining an address of each of the target memory pages respectively corresponding to the at least one target logical block according to the starting logical block address, the number of logical blocks, the first physical region page pointer, and the second physical region page pointer, wherein each of the target memory pages respectively corresponding to the target logical blocks is one of the at least one target memory page; and
selecting a first target logical block from the at least one target logical block, reading first target data according to the obtained address of a first target memory page corresponding to the first target logical block, and writing the read first target data into the first target logical block.

8. The data writing method according to claim 7, wherein the step of selecting the first target logical block from the at least one target logical block comprises:
determining whether each target logical block among the at least one target logical block is in a readiness state, and selecting one target logical block in the readiness state from the at least one target logical block to be the first target logical block, wherein the readiness state is configured to indicate that the logical block in the readiness state is ready to be transferred.

9. The data writing method according to claim 7, wherein the step of obtaining the address of each of the target memory pages respectively corresponding to the at least one target logical block according to the starting logical block address, the number of logical blocks, the first physical region page pointer, and the second physical region page pointer comprises:
determining whether use of the second physical region page pointer is required according to a size of each of the logical blocks, a size of each of the memory pages, the starting logical block address, the number of logical blocks, and the first physical region page pointer;
obtaining the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required; and
obtaining the address of each of the target memory pages respectively corresponding to the at least one target logical block according to the size of each of the logical blocks, the size of each of the memory pages, the starting logical block address, the number of logical blocks, and the first physical region page pointer if use of the second physical region page pointer does is not required.

10. The data writing method according to claim 9, wherein the step of determining whether use of the second physical region page pointer is required according to the size of each of the logical blocks, the size of each of the memory pages, the starting logical block address, the number of logical blocks, and the first physical region page pointer comprises:
calculating a size of the target data according to the size of each of the logical blocks and the number of logical blocks;
determining an ending address of the memory page to which the first memory page address belongs according to the size of each of the memory pages and the first physical region page pointer, and using a space between the ending address and the first memory page address as an initial memory page space; and
determining that use of the second physical region page pointer is required if the size of the target data is greater than a size of the initial memory page space.

11. The data writing method according to claim 10, wherein the step of obtaining the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required comprises:
calculating a difference obtained from the size of the target data minus the size of the initial memory page space;
identifying the second memory page address indicated by the second physical region page pointer as a list starting address of a physical region page pointer list if the difference is greater than the size of each of the memory pages, wherein the physical region page pointer list stores a plurality of entries, wherein each entry among the entries records one memory page address; and
determining the address of each of the target memory pages respectively corresponding to the at least one target logical block according to the initial memory page space and the physical region page pointer list.

12. The data writing method according to claim 11, wherein the step of obtaining the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required further comprises:
identifying the second memory page address indicated by the second physical region page pointer as a starting address of a remaining memory page if the difference is not greater than the size of each of the memory pages; and
determining the address of each of the target memory pages respectively corresponding to the at least one target logical block according to the initial memory page space and the starting address of the remaining memory page.

13. A storage controller, configured to control a storage device having a rewritable non-volatile memory module, the storage controller comprising:
a connection interface circuit, configured to couple to a host system, wherein the host system has a host memory, wherein the host memory has a plurality of memory pages;
a memory interface control circuit, configured to couple to the rewritable non-volatile memory module, wherein the rewritable non-volatile memory module is assigned with a plurality of logical blocks;
a processor, coupled to the connection interface circuit and the memory interface control circuit; and
a data transfer management circuit, coupled to the processor, the connection interface circuit and the memory interface control circuit,
wherein the processor is configured to receive a read command from the host system, wherein the read command comprises a starting logical block address, a number of logical blocks, a first physical region page pointer, and a second physical region page pointer, wherein the read command is configured to read target data from at least one target logical block of the rewritable non-volatile memory module and write the read target data into at least one target memory page of the host memory, wherein the target data is stored starting from a starting logical block in the at least one target logical block, wherein the starting logical block address is configured to indicate an address of the starting logical block, the number of logical blocks is configured to indicate a number of the logical blocks storing the target data in the at least one target logical block, the first physical region page pointer is configured to indicate a first memory page address of the host memory, and the second physical region page pointer is configured to indicate a second memory page address of the host memory,
wherein the processor is configured to instruct the data transfer management circuit to obtain an address of each of the target memory pages respectively corresponding to the at least one target logical block according to the starting logical block address, the number of logical blocks, the first physical region page pointer, and the second physical region page pointer,
wherein the memory interface control circuit is configured to select a first target logical block from the at least one target logical block, and read first target data stored by the first target logical block,
wherein the data transfer management circuit is configured to write the read first target data into a first target memory page according to the obtained address of the first target memory page corresponding to the first target logical block.

14. The storage controller according to claim 13, wherein in the operation where the memory interface control circuit is configured to select the first target logical block from the at least one target logical block,
the memory interface control circuit determines whether each target logical block among the at least one target logical block is in a readiness state, and selects one target logical block in the readiness state from the at least one target logical block to be the first target logical block, wherein the readiness state is configured to indicate that the logical block in the readiness state is ready to be transferred.

15. The storage controller according to claim 13, wherein in the operation where the data transfer management circuit obtains the address of each of the target memory pages respectively corresponding to the at least one target logical block according to the starting logical block address, the number of logical blocks, the first physical region page pointer, and the second physical region page pointer,
the data transfer management circuit determines whether use of the second physical region page pointer is required according to a size of each of the logical blocks, a size of each of the memory pages, the starting logical block address, the number of logical blocks, and the first physical region page pointer,
wherein the data transfer management circuit obtains the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required,
wherein the data transfer management circuit obtains the address of each of the target memory pages respectively corresponding to the at least one target logical block according to the size of each of the logical blocks, the size of each of the memory pages, the starting logical block address, the number of logical blocks, and the first physical region page pointer if use of the second physical region page pointer does is not required.

16. The storage controller according to claim 15, wherein in the operation where the data transfer management circuit determines whether use of the second physical region page pointer is required according to the size of each of the logical blocks, the size of each of the memory pages, the starting logical block address, the number of logical blocks, and the first physical region page pointer,
the data transfer management circuit calculates a size of the target data according to the size of each of the logical blocks and the number of logical blocks,
wherein the data transfer management circuit determines an ending address of the memory page to which the first memory page address belongs according to the size of each of the memory pages and the first physical region page pointer, and uses a space between the ending address and the first memory page address as an initial memory page space,
wherein the data transfer management circuit determines that use of the second physical region page pointer is required if the size of the target data is greater than a size of the initial memory page space.

17. The storage controller according to claim 16, wherein in the operation where the data transfer management circuit obtains the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required,
the data transfer management circuit calculates a difference obtained from the size of the target data minus the size of the initial memory page space,
wherein the data transfer management circuit identifies the second memory page address indicated by the second physical region page pointer as a list starting address of a physical region page pointer list if the difference is greater than the size of each of the memory pages, wherein the physical region page pointer list stores a plurality of entries, wherein each entry among the entries records one memory page address,
wherein the data transfer management circuit determines the address of each of the target memory pages respectively corresponding to the at least one target logical block according to the initial memory page space and the physical region page pointer list.

18. The storage controller according to claim 17, wherein in the operation of obtaining the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required,
the data transfer management circuit identifies the second memory page address indicated by the second physical region page pointer as a starting address of a remaining memory page if the difference is not greater than the size of each of the memory pages,
wherein the data transfer management circuit determines the address of each of the target memory pages respectively corresponding to the at least one target logical block according to the initial memory page space and the starting address of the remaining memory page.

19. A storage controller, configured to control a storage device having a rewritable non-volatile memory module, the storage controller comprising:
a connection interface circuit, configured to couple to a host system, wherein the host system has a host memory, wherein the host memory has a plurality of memory pages;
a memory interface control circuit, configured to couple to the rewritable non-volatile memory module, wherein the rewritable non-volatile memory module is assigned with a plurality of logical blocks;
a processor, coupled to the connection interface circuit and the memory interface control circuit; and
a data transfer management circuit, coupled to the processor, the connection interface circuit and the memory interface control circuit,
wherein the processor is configured to receive a write command from the host system, wherein the write command comprises a starting logical block address, a number of logical blocks, a first physical region page pointer, and a second physical region page pointer, wherein the write command is configured to write target data into at least one target logical block of the rewritable non-volatile memory module, wherein a foremost logical block sorted in the at least one target logical block is a starting logical block, wherein the starting logical block address is configured to indicate an address of the starting logical block, the number of logical blocks is configured to indicate a number of the logical blocks storing the target data in the at least one target logical block, the first physical region page pointer is configured to indicate a first memory page address of the host memory, and the second physical region page pointer is configured to indicate a second memory page address of the host memory, wherein the target data corresponding to the write command is stored in at least one target memory page among the memory pages of the host memory,
wherein the processor is configured to instruct the data transfer management circuit to obtain an address of each of the target memory pages respectively corresponding to the at least one target logical block according to the starting logical block address, the number of logical blocks, the first physical region page pointer, and the second physical region page pointer, wherein each of the target memory pages respectively corresponding to the target logical blocks is one of the at least one target memory page,
wherein the memory interface control circuit is configured to select a first target logical block from the at least one target logical block,
wherein the data transfer management circuit is configured to read first target data according to the obtained address of a first target memory page corresponding to the first target logical block, and the memory interface control circuit is further configured to write the read first target data into the first target logical block.

20. The storage controller according to claim 19, wherein in the operation where the memory interface control circuit is configured to select the first target logical block from the at least one target logical block,
the memory interface control circuit determines whether each target logical block among the at least one target logical block is in a readiness state, and selects one target logical block in the readiness state from the at least one target logical block to be the first target logical block, wherein the readiness state is configured to indicate that the logical block in the readiness state is ready to be transferred.

21. The storage controller according to claim 19, wherein in the operation where the data transfer management circuit obtains the address of each of the target memory pages respectively corresponding to the at least one target logical block according to the starting logical block address, the number of logical blocks, the first physical region page pointer, and the second physical region page pointer,
the data transfer management circuit determines whether use of the second physical region page pointer is required according to a size of each of the logical blocks, a size of each of the memory pages, the starting logical block address, the number of logical blocks, and the first physical region page pointer,
wherein the data transfer management circuit obtains the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required,
wherein the data transfer management circuit obtains the address of each of the target memory pages respectively corresponding to the at least one target logical block according to the size of each of the logical blocks, the size of each of the memory pages, the starting logical block address, the number of logical blocks, and the first physical region page pointer if use of the second physical region page pointer does is not required.

22. The storage controller according to claim 21, wherein in the operation where the data transfer management circuit determines whether use of the second physical region page pointer is required according to the size of each of the logical blocks, the size of each of the memory pages, the starting logical block address, the number of logical blocks, and the first physical region page pointer,
the data transfer management circuit calculates a size of the target data according to the size of each of the logical blocks and the number of logical blocks,
wherein the data transfer management circuit determines an ending address of the memory page to which the first memory page address belongs according to the size of each of the memory pages and the first physical region page pointer, and uses a space between the ending address and the first memory page address as an initial memory page space,
wherein the data transfer management circuit determines that use of the second physical region page pointer is required if the size of the target data is greater than a size of the initial memory page space.

23. The storage controller according to claim 22, wherein in the operation where the data transfer management circuit obtains the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required,
the data transfer management circuit calculates a difference obtained from the size of the target data minus the size of the initial memory page space,
wherein the data transfer management circuit identifies the second memory page address indicated by the second physical region page pointer as a list starting address of a physical region page pointer list if the difference is greater than the size of each of the memory pages, wherein the physical region page pointer list stores a plurality of entries, wherein each entry among the entries records one memory page address,
wherein the data transfer management circuit determines the address of each of the target memory pages respectively corresponding to the at least one target logical block according to the initial memory page space and the physical region page pointer list.

24. The storage controller according to claim 23, wherein in the operation where the data transfer management circuit obtains the address of each of the target memory pages respectively corresponding to the at least one target logical block according to the size of each of the logical blocks, the size of each of the memory pages, the starting logical block address, the number of logical blocks, the first physical region page pointer, and the second physical region page pointer if use of the second physical region page pointer is required,
the data transfer management circuit identifies the second memory page address indicated by the second physical region page pointer as a starting address of a remaining memory page if the difference is not greater than the size of each of the memory pages,
wherein the data transfer management circuit determines the address of each of the target memory pages respectively corresponding to the at least one target logical block according to the initial memory page space and the starting address of the remaining memory page.
